(19) United States
(12) Patent Application Publication
(10) Pub. No.: US 2024/0160919 A1
(43) Pub. Date: May 16, 2024

(54) METHOD AND SYSTEM FOR QUANTIZATION-AWARE-TRAINING WITH KERNEL REPARAMETERIZATION

(71) Applicant: MEDIATEK INC., Hsinchu (TW)

(72) Inventors: Po-Hsiang Yu, Hsinchu (TW); Hao Chen, Hsinchu (TW); Peng-Wen Chen, Hsinchu (TW); Cheng-Yu Yang, Hsinchu (TW)

(21) Appl. No.: 18/380,725

(22) Filed: Oct. 17, 2023

Related U.S. Application Data
(60) Provisional application No. 63/383,513, filed on Nov. 14, 2022.

(51) Int. Cl. G06N 3/08; G06N 3/0464

(52) U.S. Cl. CPC G06N 3/08; G06N 3/0464

(57) ABSTRACT

In aspects of the disclosure, a method, a system, and a computer-readable medium are provided. The method of building a kernel reparameterization for replacing a convolution-wise operation kernel in training of a neural network comprises selecting one or more blocks from tensor blocks and operations; and connecting the selected one or more blocks with the selected operations to build the kernel reparameterization. The kernel reparameterization has a dimension same as that of the convolution-wise operation kernel.

### CROSS-REFERENCE TO RELATED APPLICATION(S)

This application claims the benefits of U.S. Provisional Application Ser. No. 63/385,513, entitled “Efficient Inference Using Reparameterization for Edge Device” and filed on Nov. 14, 2022, which is expressly incorporated by reference herein in its entirety.

### BACKGROUND

### Field

The present disclosure relates generally to content delivery, and more particularly, to method and system of quantization-aware-training with a kernel reparameterization.

### Background

The statements in this section merely provide background information related to the present disclosure and may not constitute prior art.

Convolution is an extensively used component in modern deep neural networks. Deep neural network inference on mobile devices tends to have limited computing resource, power and memory, while on the other hands, the training of these model often scales to very large extent. If one can use tricks to expand the network structure to a strong representation during training phase while keeping the same inference model, it would have great benefit.

Reparameterization is an approach to expand the model at training phase while remain the original topology at inference.

To deploy artificial intelligence (AI) application efficiently on mobile devices, the bit-width of parameter weight and activation needs to be quantized to save memory, power and latency. Quantization-aware training (QAT) is a common practice to preserve quantized neural network accuracy. It inserts “fake quant” operator to count the min/max value and transform the value of weight/activation based on the value. To achieve desired QAT behavior, the position of fake quant must be correctly set.

Conventional structural reparameterization is hard to perform QAT. The min/max values of the expanded block cannot be simply recorded by a single fake quant.

Therefore, a heretofore unaddressed need exists in the art to address the deficiencies and inadequacies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In aspects of the disclosure, a method, a system, and a computer-readable medium, are provided.

In one aspect, the disclosure provides a method of building a kernel reparameterization for replacing a convolution-wise operation kernel in training of a neural network. The method includes selecting one or more blocks from tensor blocks and operations; and connecting the selected one or more blocks with the selected operations to build the kernel reparameterization. The kernel reparameterization has a dimension same as that of the convolution-wise operation kernel.

In one embodiment, the tensor blocks comprise a 1×1 kernel, a 1×N kernel, an N×1 kernel, an M×P kernel, an N×N kernel, and an identify kernel, wherein M≤N, P≤N, and each M, N, and P is a natural number.

In one embodiment, the selected operations comprise one or more operations of add, convolution, concatenation, and element-wise.

In one embodiment, the kernel reparameterization is a linear combination of the selected one or more tensor blocks.

In one embodiment, the convolution-wise operation comprises one or more operations of convolution, deconvolution or transposed convolution, deformable convolution, depth-wise convolution, and grouped convolution, with any stride, dilation, and padding.

Another aspect of the disclosure relates to a kernel reparameterization built according to the above method used in training of the neural network.

In a further aspect, the disclosure relates to a method of performing quantization aware training (QAT) of a neural network. The method includes:
(a) identifying a convolution-wise operation kernel in training of the neural network;
(b) selecting one or more blocks from tensor blocks and operations;
(c) connecting the selected one or more blocks with the selected operations to build a kernel reparameterization, wherein the kernel reparameterization has a dimension same as that of the convolution-wise operation kernel;
(d) replacing the convolution-wise operation kernel with the kernel reparameterization;
(e) adding fake quant operator right after the convolution-wise operation; and
(f) performing quantization-aware-training of the neural network with the kernel reparameterization, wherein the kernel weight is calculated on-the-fly using step (c).

In one embodiment, the tensor blocks comprise a 1×1 kernel, a 1×N kernel, an N×1 kernel, an M×P kernel, an N×N kernel, and an identify kernel, wherein M≤N, P≤N, and each M, N, and P is a natural number.

In one embodiment, the selected operations comprise one or more operations of add, convolution, concatenation, and element-wise.

In one embodiment, the kernel reparameterization is a linear combination of the selected one or more tensor blocks.

In one embodiment, the convolution-wise operation comprises one or more operations of convolution, deconvolution or transposed convolution, deformable convolution, depth-wise convolution, and grouped convolution, with any stride, dilation, and padding.

In one aspect, the disclosure relates to a system for performing quantization aware training (QAT) of a neural network.

The system includes at least one storage memory operable to store data along with computer-executable instructions; and at least one processor operable to read the data and operate the computer-executable instructions to:
(a) identify a convolution-wise operation kernel in training of the neural network;
(b) select one or more blocks from tensor blocks and operations;
(c) connect the selected one or more blocks with the selected operations to build a kernel reparameterization, wherein the kernel reparameterization has a dimension same as that of the convolution-wise operation kernel;
(d) replace the convolution-wise operation kernel with the kernel reparameterization;
(e) add fake quant operator right after the convolution-wise operation; and
(f) perform quantization-aware-training of the neural network with the kernel reparameterization, wherein the kernel weight is calculated on-the-fly using step (c).

In one embodiment, the tensor blocks comprise a 1×1 kernel, a 1×N kernel, an N×1 kernel, an M×P kernel, an N×N kernel, and an identify kernel, wherein M≤N, P≤N, and each M, N, and P is a natural number.

In one embodiment, the selected operations comprise one or more operations of add, convolution, concatenation, and element-wise.

In one embodiment, n the kernel reparameterization is a linear combination of the selected one or more tensor blocks.

In one embodiment, the convolution-wise operation comprises one or more operations of convolution, deconvolution or transposed convolution, deformable convolution, depth-wise convolution, and grouped convolution, with any stride, dilation, and padding.

In another aspect, the disclosure provides anon-transitory tangible computer-readable medium storing computer-executable instructions which, when executed by one or more processors, cause a system to perform the above-disclosed method of QAT with the kernel reparameterization.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 shows schematically a normal convolution, a conventional structural reparameterization, and a kernel reparameterization for training of a neural network according to some embodiments of the invention.

FIG. 2 shows a set of tensor blocks including a 1×1 kernel, a 1×N kernel, an N×1 kernel, an M×P kernel, an N×N kernel, and an identify kernel, wherein M≤N, P≤N, and each M, N, and P is a natural number.

FIG. 3 shows operation symbols representing add, convolution, concatenation, and elementwise operations, respectively.

FIG. 4 shows an embodiment of the kernel reparameterization according to the invention.

FIG. 5 shows schematically quantization aware training (QAT) with a structural reparameterization, where weight fake quants are applied for convolution weight entities, and activation fake quants are applied for convolution outputs.

FIG. 6 shows schematically a QAT framework with a kernel reparameterization according to some embodiments of the invention, where only a single weight fake quant is applied for a convolution weight entity, and only a single activation fake quant is applied for a convolution output.

FIG. 7 shows schematically inference/deployment according to some embodiments of the invention, where fake quant operation is only added after the deployment convolution weight.

FIG. 8 shows schematically QAT and deployment of a neural network according to some embodiments of the invention. Since at inference (actual model deployment) there only is one convolution, the kernel reparameterization can correctly mimic the inference behavior at training time.

FIG. 9 shows schematically a reparameterization QAT pipeline equipped with the kernel reparameterization according to some embodiments of the invention.

FIG. 10 shows applications: using kernel reparameterization QAT pipeline to boost accuracy of quantized small model according to some embodiments of the invention.

FIG. 11 shows a flowchart of a method for performing QAT of a neural network, according to some embodiments of the invention.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

Convolution operator is a widely used component under the current deep neural network architecture. There may exist problems when deploying such a network on mobile devices and some edge devices, since these devices often do not have relatively large computing resources. To solve such problems, a common method is to make a distinction between the architecture during training and influence, which is the architecture during actual deployment. If one can use a more complex architecture during training and then use a simpler architecture during deployment, and make the two architecture areas consistent, one can train the network better during training and save power, memory, and related resources during deployment. One of the more commonly used methods is reparameterization. The technology of reparameterization is to distinguish the network architecture during training and deployment. In addition to this, another technology used in training and inference is to quantize the precision of the network, which is the weight of the network and the bit width of the activation. It is from a relatively high precision level of 32 bit or 16 bit and then quantize it to a relatively low precision, e.g., 8 bit, 4 bit or even a lower level. This can ben achieved with quantization aware training (QAT) when doing network training, which is to add an operator called non-quant before and after the weight and activation of the original network. The purpose of the additional inserted operator is to calculate the weight and the mean of the activation, which is the minimum value and maximum value to count such values so that when one finally does deployment, one can quantize the weight and activation to the needed precision. To obtain such a decouple technology, one adopts the reparameterization technology. However, the conventional structural reparameterization is technically difficult to achieve such quantization aware training because it is difficult for the structural reparameterization, which calculates a non-quant such as mean-max value and does not have a suitable position for placement. First of all, the conventional structural reparameterization is a method of the existing learning base. This method is specifically to remove some branches in the network architecture, i.e., some residuals. The disadvantages of the structural reparameterization are as follows. First, it must be designed for an entire network architecture, that is, to design a brand-new network architecture rather than a plug-and-play one. Second, it is an expanded structural reparameterization technology, which is not friendly to the quantization aware training that one needs when the network is deployed, and there is no way to use it directly.

In view of the foregoing, the disclosure provides a novel reparameterization technology, called the kernel reparameterization herein. The difference between the novel reparameterization technology and other technologies is that the convolution operation and its weight are decoupled. The novel technology is only used on the weight of the convolution kernel and does not directly affect the operation of the convolution. Further, the novel reparameterization technology solves the problem of aware training that the original reparameterization cannot be used together with quantization aware training.

Specifically, one aspect of the disclosure provides a method of building a kernel reparameterization for replacing a convolution-wise operation kernel in training of a neural network. The method includes selecting one or more blocks from tensor blocks and operations; and connecting the selected one or more blocks with the selected operations to build the kernel reparameterization. The kernel reparameterization has a dimension same as that of the convolution-wise operation kernel.

In some embodiments, the tensor blocks comprise a 1×1 kernel, a 1×N kernel, an N×1 kernel, an M×P kernel, an N×N kernel, and an identify kernel, wherein M≤N, P≤N, and each M, N, and P is a natural number.

In some embodiments, the selected operations comprise one or more operations of add, convolution, concatenation, and element-wise.

In some embodiments, the kernel reparameterization is a linear combination of the selected one or more tensor blocks.

In some embodiments, the convolution-wise operation comprises one or more operations of convolution, deconvolution or transposed convolution, deformable convolution, depth-wise convolution, and grouped convolution, with any stride, dilation, and padding.

Another aspect of the disclosure relates to a kernel reparameterization built according to the above method used in training of the neural network.

Yet another aspect of the disclosure relates to a method of performing quantization aware training (QAT) of a neural network. The method includes:
(a) identifying a convolution-wise operation kernel in training of the neural network;
(b) selecting one or more blocks from tensor blocks and operations;
(c) connecting the selected one or more blocks with the selected operations to build a kernel reparameterization, wherein the kernel reparameterization has a dimension same as that of the convolution-wise operation kernel;
(d) replacing the convolution-wise operation kernel with the kernel reparameterization;
(e) adding fake quant operator right after the convolution-wise operation; and
(f) performing quantization-aware-training of the neural network with the kernel reparameterization, wherein the kernel weight is calculated on-the-fly using step (c).

In some embodiments, the tensor blocks comprise a 1×1 kernel, a 1×N kernel, an N×1 kernel, an M×P kernel, an N×N kernel, and an identify kernel, wherein M≤N, P≤N, and each M, N, and P is a natural number.

In some embodiments, the selected operations comprise one or more operations of add, convolution, concatenation, and element-wise.

In some embodiments, the kernel reparameterization is a linear combination of the selected one or more tensor blocks.

In some embodiments, the convolution-wise operation comprises one or more operations of convolution, deconvolution or transposed convolution, deformable convolution, depth-wise convolution, and grouped convolution, with any stride, dilation, and padding.

In one aspect, the disclosure relates to a system for performing quantization aware training (QAT) of a neural network. The system includes at least one storage memory operable to store data along with computer-executable instructions; and at least one processor operable to read the data and operate the computer-executable instructions to:
(a) identify a convolution-wise operation kernel in training of the neural network;
(b) select one or more blocks from tensor blocks and operations;
(c) connect the selected one or more blocks with the selected operations to build a kernel reparameterization, wherein the kernel reparameterization has a dimension same as that of the convolution-wise operation kernel;
(d) replace the convolution-wise operation kernel with the kernel reparameterization;
(e) add fake quant operator right after the convolution-wise operation; and
(f) perform quantization-aware-training of the neural network with the kernel reparameterization, wherein the kernel weight is calculated on-the-fly using step (c).

In some embodiments, the tensor blocks comprise a 1×1 kernel, a 1×N kernel, an N×1 kernel, an M×P kernel, an N×N kernel, and an identify kernel, wherein M≤N, P≤N, and each M, N, and P is a natural number.

In some embodiments, the selected operations comprise one or more operations of add, convolution, concatenation, and element-wise.

In some embodiments, n the kernel reparameterization is a linear combination of the selected one or more tensor blocks.

In some embodiments, the convolution-wise operation comprises one or more operations of convolution, deconvolution or transposed convolution, deformable convolution, depth-wise convolution, and grouped convolution, with any stride, dilation, and padding.

In another aspect, the disclosure provides anon-transitory tangible computer-readable medium storing computer-executable instructions which, when executed by one or more processors, cause a system to perform the above-disclosed method of QAT with the kernel reparameterization.

In the following description, numerous specific details are set forth regarding the systems and methods of the disclosed subject matter and the environment in which such systems and methods may operate, etc., to provide a thorough understanding of the disclosed subject matter. In addition, it will be understood that the examples provided below are exemplary, and that it is contemplated that there are other systems and methods that are within the scope of the disclosed subject matter.

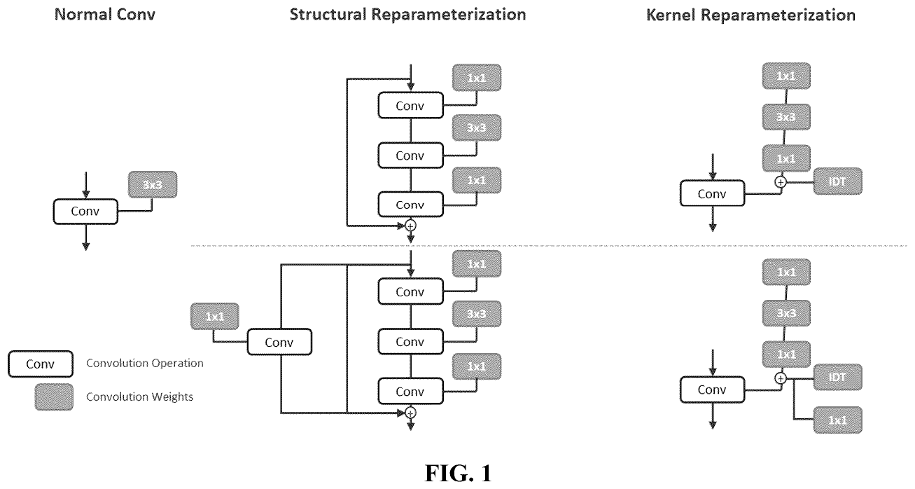

FIG. 1 shows schematically a normal convolution, a conventional structural reparameterization, and a kernel reparameterization for training of a neural network according to some embodiments of the invention. For a typical normal convolution, the weight is its kernel, as shown in the left of FIG. 1. For a conventional structural reparameterization, as shown in the middle of FIG. 1, it uses an expansion method for the normal convolution, which establishes different convolution operations. Then each convolution operation has its weight. As shown in the right of FIG. 1, the novel kernel reparameterization according to some embodiments of the invention has only one operation like the general convolution. However, the weight of the convolution is composed of multiple different weights. The novel kernel reparameterization only has a single convolution operation, but the weight is composed of different kernel weights like the structural reparameterization. So, one can replace any operations related to convolution. Related operations include, but are not limited to, general convolution deconvolution, deformable convolution depth-wise convolution, group convolution, etc. There are no restrictions on the stride, dilation, and padding of the convolution. Since one can replace any of these operations related to convolution, the application level is not limited to general classification object detection, etc., but as long as there are some applications that use convolution-related operators, the novel technology can be applied.

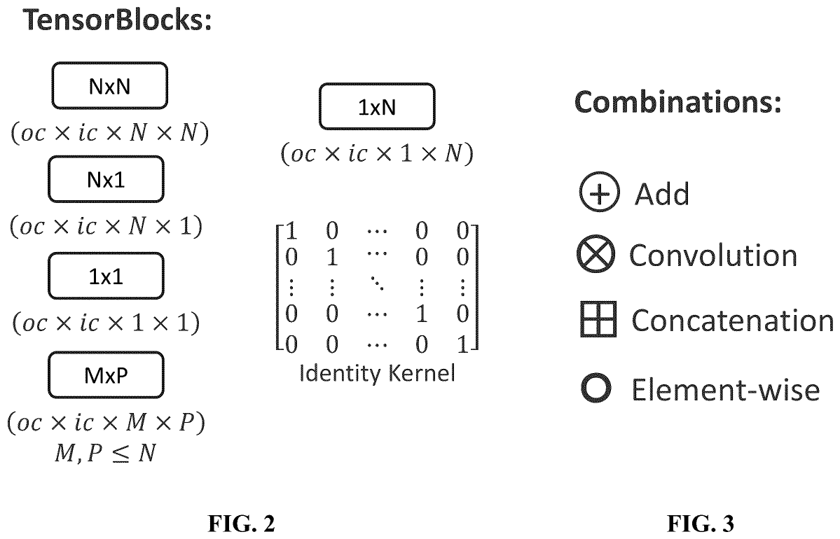

FIG. 2 shows a set of tensor blocks including a 1×1 kernel, a 1×N kernel, an N×1 kernel, an M×P kernel, an N×N kernel, and an identify kernel, wherein M≤N, P≤N, and each M, N, and P is a natural number.

FIG. 3 shows operation symbols representing add, convolution, concatenation, and elementwise operations, respectively.

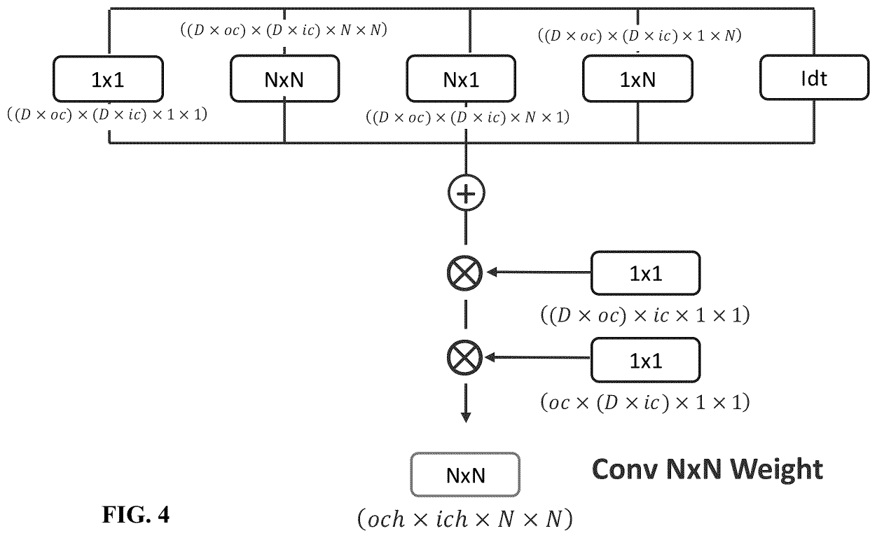

FIG. 4 shows an embodiment of the kernel reparameterization according to the invention. The kernel reparameterization is a block of reparameterization. First, the block of reparameterization can replace any kernel of convolution N×N. The way to build the block of reparameterization is to use some different combinations of tensor blocks (FIG. 2) to perform different operations (FIG. 3) to connect the different tensor blocks. The size of the convolution kernel can be any size as long as N is a natural number and there are no restrictions. The linear combination mainly listed in FIG. 3 includes add, convolution, concatenation, and element-wise operations. The tensor blocks a 1×1 kernel, a 1×N kernel, an N×1 kernel, an M×P kernel, an N×N kernel, and an identify kernel, wherein M≤N, P≤N, and each M, N, and P is a natural number. With the addition of the identity kernel, through the combination of different tensor blocks, the kernel reparameterization shown in FIG. 4 can be obtained, which includes adding the five kernels of 1×1, N×N, N×1, 1×N and identity first and then adding them to the two 1×1 convolution kernels, respectively. Finally, one only needs its dimension to have a weight that matches the original convolution N×N kernel. We can replace the weight of the original convolution N×N with the block of reparameterization above through such a combination. The combined kernel block can be used for quantization aware training.

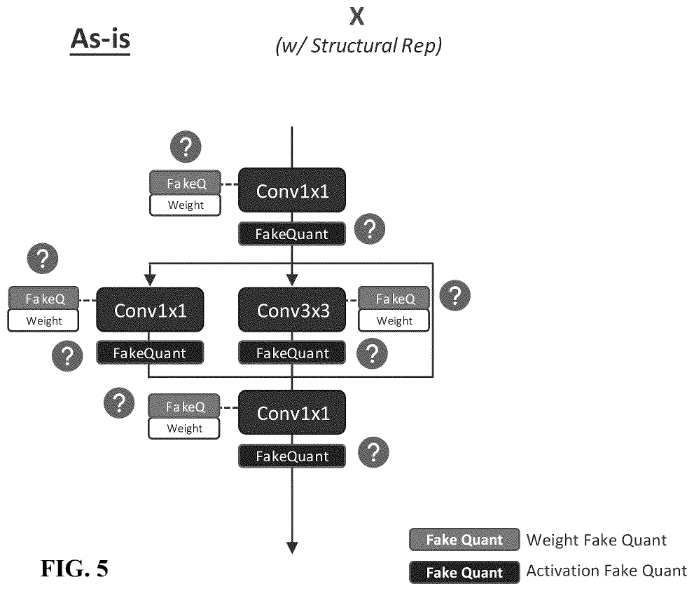

FIG. 5 shows schematically quantization aware training with a conventional structural reparameterization, where weight fake quants are applied for convolution weight entities, and activation fake quants are applied for convolution outputs. As shown in FIG. 5, the original architecture is the structural reparameterization architecture, where each convolution operation must be established. The essence of training for quantization aware is that each convolution operation must count its maximum and minimum values. In use, it inserts an operator that counts the maximum and minimum values behind each convolution. In fact, there may be problems in statistics.

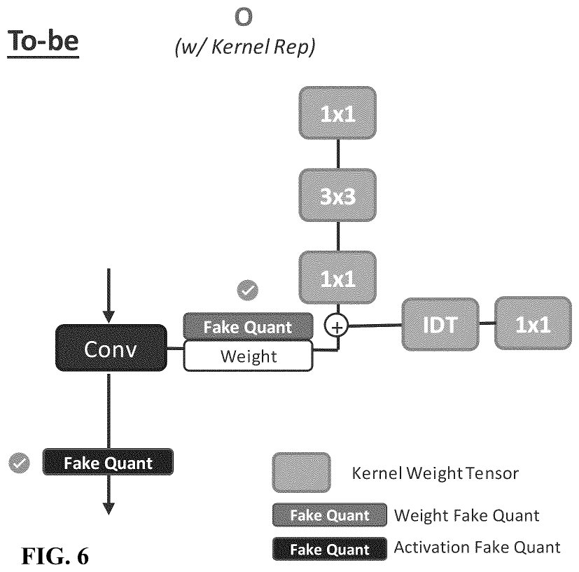

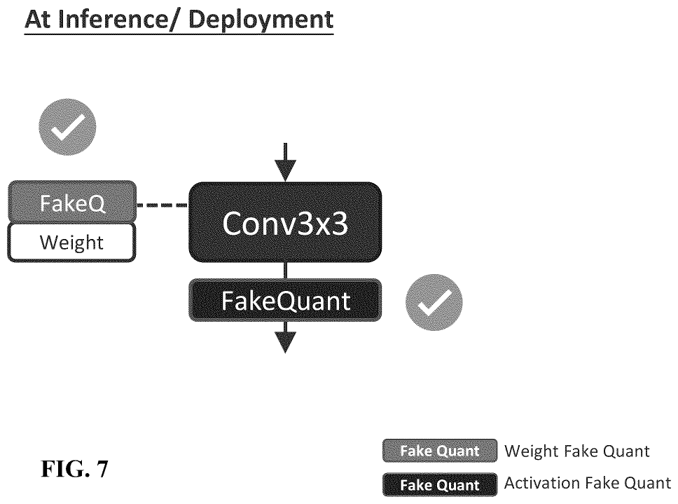

Referring to FIG. 6, a quantization aware training framework with a kernel reparameterization is schematically shown according to some embodiments of the invention, where only a single weight fake quant is applied for a convolution weight entity, and only a single activation fake quant is applied for a convolution output. FIG. 7 shows schematically inference/deployment according to some embodiments of the invention, where fake quant operation is only added after the deployment convolution weight. Since the architecture as shown in FIG. 7 when deploying it, there is only one convolution operation, it must only have one operator that counts the maximum and minimum values of the convolution. The structure is that we use convolution through the expansion method as we did before. After replacing it, since we have only one operator, the weight of convolution is also only one, so we only need to record the maximum and minimum values of the previous series of operations on this weight. Then we can have the same architecture as when deployed without encountering the situation shown on FIG. 5. During training, a very complicated expanded block is used to combine a weight of a convolution, as disclosed above. When selecting a combined block as shown in FIG. 6 to replace the weight of the convolution kernel, we will count its size value. This operator just directly counts the weight of the final combined convolution. In fact, there is no need to do extra things during deployment because the weight is important for the convolution during deployment, which is also only one weight, thereby eliminating the problem that the conventional structural reparameterization method has.

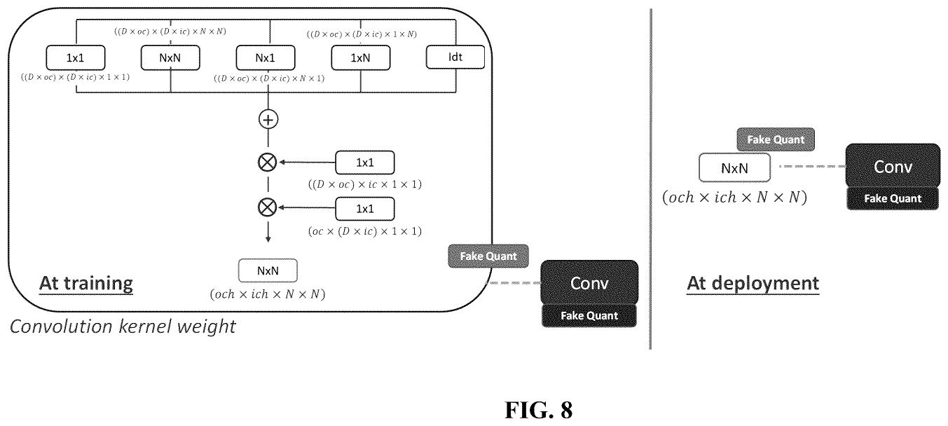

Referring to FIG. 8, QAT and deployment of a neural network are schematically shown according to some embodiments of the invention. Since at inference (actual model deployment) there only is one convolution, the kernel reparameterization can correctly mimic the inference behavior at training time. According to the invention, the weight of the original convolution N×N is replaced with the block of the kernel reparameterization, i.e., convolution kernel weight shown in FIG. 8. When doing the QAT training, the fake quant operator is directly connected to the kernel weight, and the weight value of N×N is counted.

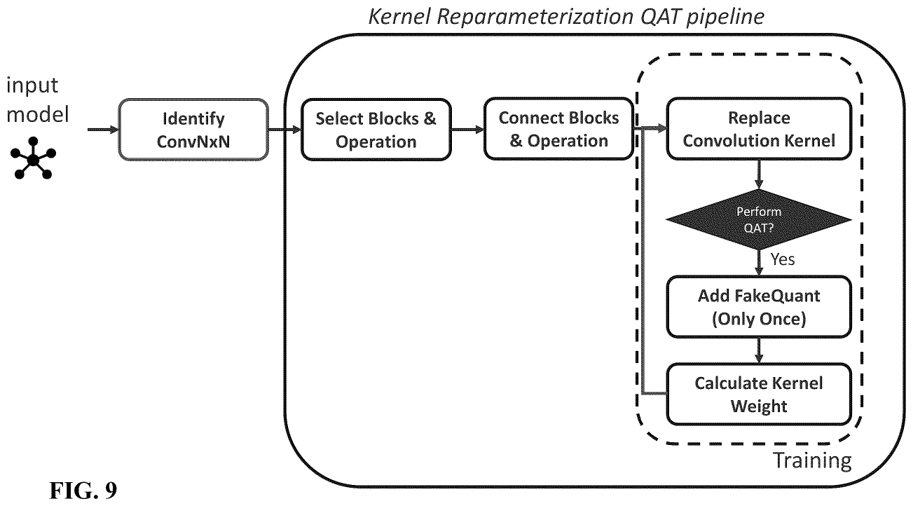

FIG. 9 shows schematically a reparameterization QAT pipeline equipped with the kernel reparameterization according to some embodiments of the invention. The exemplary QAT pipeline includes an input model, and a network. First, the input model is used to identify all the N×N convolutions in this model. Then, the tensor blocks and operations are selected to build the kernel reparameterization. The selected tensor blocks are connected/combined with the selected operations to form a kernel weight that is same as the weight dimension of the original convolution. According to the invention, there is no limit to what kind of operations to use to connect the selected tensor blocks, the only condition is the dimension of the final connection must be consistent with the weight of the original convolution. The weight is then used to replace the convolution kernel. Then there is a reciprocating training process here. Because the exemplary pipeline is focused on quantization aware training, the fake quant is added. Next to the kernel, its maximum and minimum values are counted. Then the next step is to continuously calculate this weight during the training process. The calculation method is to use the connection methods of the operations mentioned above to calculate that calculation. When doing the QAT training, the fake quant operator is directly connected to the kernel weight, and the weight value of N×N is counted. These steps are repeated, that is, this weight is passed through the combination of the above operations and then through these combinations during training. After that, we will continue to use the results of this calculation to replace the convolution kernel next time until the end of the training.

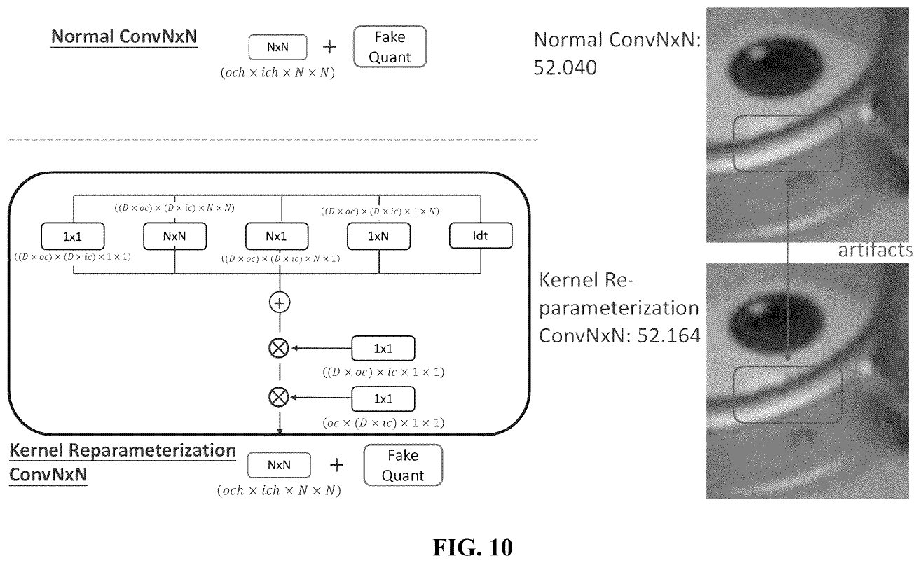

Referring to FIG. 10, applications of using the kernel reparameterization QAT pipeline to boost accuracy of quantized small model are shown according to some embodiments of the invention. As shown in FIG. 10, using the kernel reparameterization QAT method on a picture, the output picture has a better quality, compared with that of the normal convolution method. The output picture (image) from the normal convolution method has some noises or artifacts on it, as shown in the top right panel. After using the kernel reparameterization QAT method, these noise points and artifacts are removed from the output picture, as shown in the bottom right panel.

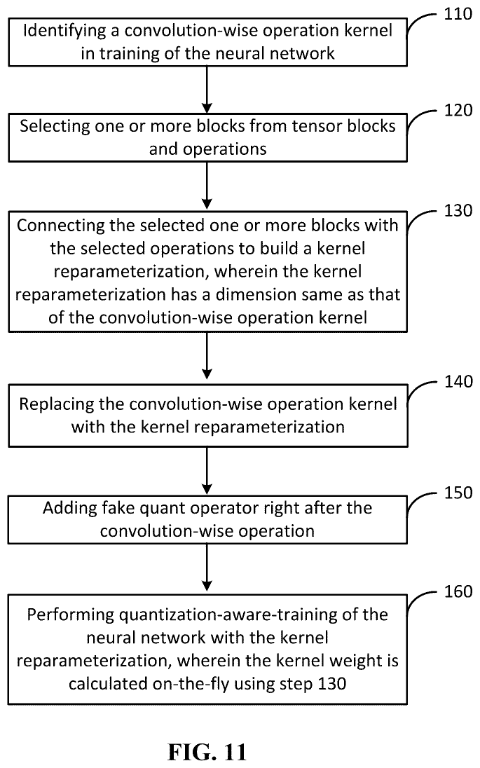

Referring to FIG. 11 a flowchart for the method of performing QAT of a neural network, according to some embodiments of the invention. The method in some embodiments is performed before the neural network is deployed.

According to the method, at step 110, a convolution-wise operation kernel in training of the neural network is identified, based on an input model of the neural network.

In some examples, the convolution-wise operation includes one or more operations of convolution, deconvolution or transposed convolution, deformable convolution, depth-wise convolution, and grouped convolution, with any stride, dilation, and padding.

At step 120, one or more blocks from tensor blocks and operations are selected. In some examples, the tensor blocks comprise a 1×1 kernel, a 1×N kernel, an N×1 kernel, an M×P kernel, an N×N kernel, and an identify kernel, where M≤N, P≤N, and each M, N, and P is a natural number. The selected operations include one or more operations of add, convolution, concatenation, and element-wise.

The selected one or more blocks are connected with the selected operations to build a kernel reparameterization at step 130. The kernel reparameterization has a dimension same as that of the convolution-wise operation kernel. In some embodiments, the kernel reparameterization is a linear combination of the selected one or more tensor blocks. According to the invention, there is no limit to what kind of operations to use to connect or combine the selected tensor blocks, the only condition is the dimension of the final connection must be consistent with the weight of the original convolution.

At step 140, the convolution-wise operation kernel is replaced with the kernel reparameterization. Then there is a reciprocating training process hereinafter.

At step 150, fake quant operator is added right after the convolution-wise operation.

At step 160, the QAT of the neural network is performed with the kernel reparameterization. In some embodiments, the kernel weight is calculated on-the-fly using step 130. According to the method, when doing the QAT training, the fake quant operator is directly connected to the kernel weight, and the weight value of N×N is counted. These steps are repeated, that is, this weight is passed through the combination of the above operations and then through these combinations during training. After that, the results of this calculation are continuously used to replace the convolution kernel next time until the end of the training.

In sum, the invention provides, among other things, two solutions: the block of the kernel reparameterization and the pipeline of quantization award training. As for the first solution, the block is a convenient and flexible plug-in compared with the previous structural reparameterization and the original reparameterization. That is, it can be applied to any convolution and any model. As for the second solution, the kernel reparameterization and expanded block technology can coexist for a pipeline of quantization award training that is necessary for deployment. Therefore, it can get a better quantization award training result.

It should be noted that all or a part of the steps of the method according to the embodiments of the invention is implemented by hardware or a software module executed by a processor, or implemented by a combination thereof. In one aspect, the invention provides a system comprising at least one storage memory operable to store data along with computer-executable instructions; and at least one processor operable to read the data and operate the computer-executable instructions to perform the method of QAT of a neural network as disclosed above.

Yet another aspect of the invention provides a non-transitory tangible computer-readable medium storing computer-executable instructions which, when executed by one or more processors, cause a system to perform the above-disclosed method of QAT with the kernel reparameterization. The computer executable instructions or program codes enable a computer or a similar computing system to complete various operations in the above disclosed method of foveated rendering of omnidirectional media content. The storage medium/memory may include, but is not limited to, high-speed random access medium/memory such as DRAM, SRAM, DDR RAM or other random access solid state memory devices, and non-volatile memory such as one or more magnetic disk storage devices, optical disk storage devices, flash memory devices, other non-volatile solid state storage devices, or any other type of non-transitory computer readable recoding medium commonly known in the art.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of building a kernel reparameterization for replacing a convolution-wise operation kernel in training of a neural network, comprising:
selecting one or more blocks from tensor blocks and operations; and
connecting the selected one or more blocks with the selected operations to build the kernel reparameterization, wherein the kernel reparameterization has a dimension same as that of the convolution-wise operation kernel.

2. The method of claim 1, wherein the tensor blocks comprise a 1×1 kernel, a 1×N kernel, an N×1 kernel, an M×P kernel, an N×N kernel, and an identify kernel, wherein M≤N, P≤N, and each M, N, and P is a natural number.

3. The method of claim 1, wherein the selected operations comprise one or more operations of add, convolution, concatenation, and element-wise.

4. The method of claim 3, wherein the kernel reparameterization is a linear combination of the selected one or more tensor blocks.

5. The method of claim 1, wherein the convolution-wise operation comprises one or more operations of convolution, deconvolution or transposed convolution, deformable convolution, depth-wise convolution, and grouped convolution, with any stride, dilation, and padding.

6. A kernel reparameterization built according to claim 1 used in training of the neural network.

7. A method of performing quantization aware training (QAT) of a neural network, comprising:
(a) identifying a convolution-wise operation kernel in training of the neural network;
(b) selecting one or more blocks from tensor blocks and operations;
(c) connecting the selected one or more blocks with the selected operations to build a kernel reparameterization, wherein the kernel reparameterization has a dimension same as that of the convolution-wise operation kernel;
(d) replacing the convolution-wise operation kernel with the kernel reparameterization;
(e) adding fake quant operator right after the convolution-wise operation; and
(f) performing quantization-aware-training of the neural network with the kernel reparameterization, wherein the kernel weight is calculated on-the-fly using step (c).

8. The method of claim 7, wherein the tensor blocks comprise a 1×1 kernel, a 1×N kernel, an N×1 kernel, an M×P kernel, an N×N kernel, and an identify kernel, wherein M≤N, P≤N, and each M, N, and P is a natural number.

9. The method of claim 7, wherein the selected operations comprise one or more operations of add, convolution, concatenation, and element-wise.

10. The method of claim 9, wherein the kernel reparameterization is a linear combination of the selected one or more tensor blocks.

11. The method of claim 7, wherein the convolution-wise operation comprises one or more operations of convolution, deconvolution or transposed convolution, deformable convolution, depth-wise convolution, and grouped convolution, with any stride, dilation, and padding.

12. A system for performing quantization aware training (QAT) of a neural network, comprising:
at least one storage memory operable to store data along with computer-executable instructions; and
at least one processor operable to read the data and operate the computer-executable instructions to:
(a) identify a convolution-wise operation kernel in training of the neural network;
(b) select one or more blocks from tensor blocks and operations;
(c) connect the selected one or more blocks with the selected operations to build a kernel reparameterization, wherein the kernel reparameterization has a dimension same as that of the convolution-wise operation kernel;
(d) replace the convolution-wise operation kernel with the kernel reparameterization;
(e) add fake quant operator right after the convolution-wise operation; and
(f) perform quantization-aware-training of the neural network with the kernel reparameterization, wherein the kernel weight is calculated on-the-fly using step (c).

13. The system of claim 12, wherein the tensor blocks comprise a 1×1 kernel, a 1×N kernel, an N×1 kernel, an M×P kernel, an N×N kernel, and an identify kernel, wherein M≤N, P≤N, and each M, N, and P is a natural number.

14. The system of claim 12, wherein the selected operations comprise one or more operations of add, convolution, concatenation, and element-wise.

15. The system of claim 14, wherein the kernel reparameterization is a linear combination of the selected one or more tensor blocks.

16. The system of claim 12, wherein the convolution-wise operation comprises one or more operations of convolution, deconvolution or transposed convolution, deformable convolution, depth-wise convolution, and grouped convolution, with any stride, dilation, and padding.

17. A non-transitory tangible computer-readable medium storing computer-executable instructions which, when executed by one or more processors, cause a method of quantization aware training (QAT) of a neural network to be performed, the method comprising:
(a) identifying a convolution kernel for training of the neural network;
(b) selecting one or more blocks from tensor blocks and operations;
(c) connecting the selected one or more blocks with the selected operations to build a kernel reparameterization, wherein the kernel reparameterization has a dimension same as that of the convolution kernel;
(d) replacing the convolution kernel with the kernel reparameterization;
(e) adding fake quant operator right after the convolution; and
(f) performing quantization-aware-training of the neural network with the kernel reparameterization, wherein the kernel weight is calculated on-the-fly using step (c).

18. The non-transitory tangible computer-readable medium of claim 17, wherein the tensor blocks comprise a 1×1 kernel, a 1×N kernel, an N×1 kernel, an M×P kernel, an N×N kernel, and an identify kernel, wherein M≤N, P≤N, and each M, N, and P is a natural number.

19. The non-transitory tangible computer-readable medium of claim 17, wherein the selected operations comprise one or more operations of add, convolution, concatenation, and element-wise.

20. The non-transitory tangible computer-readable medium of claim 19, wherein the kernel reparameterization is a linear combination of the selected one or more tensor blocks.
